(19) United States
(12) Patent Application Publication
(10) Pub. No.: US 2023/0158451 A1
(43) Pub. Date: May 25, 2023

(54) AUTOTHERMAL DIRECT AIR CAPTURE SYSTEM

(71) Applicants: ARIZONA BOARD OF REGENTS ON BEHALF OF ARIZONA STATE UNIVERSITY, Scottsdale, AZ (US); MAX PLANCK GESSELSCHAFT ZUR FOERDERUNG DER WISSENSCHAFT EV, Muenchen (DE)

(72) Inventors: Klaus Lackner, Paradise Valley, AZ (US); Peter Schulze, Saxony-Anhalt (DE)

(21) Appl. No.: 17/912,486

(22) PCT Filed: Mar. 16, 2021
(86) PCT No.: PCT/US2021/022575

§ 371 Date: Sep. 16, 2022

Related U.S. Application Data
(60) Provisional application No. 62/990,894, filed on Mar. 17, 2020.

(51) Int. Cl. B01D 53/62; B01D 53/04; B01D 53/82

(52) U.S. Cl. CPC B01D 53/62; B01D 53/82; B01D 53/0407; B01D 47/021; B01D 2253/25; B01D 2257/504; B01D 2258/06; B01D 2259/40083

(57) ABSTRACT

An autothermal direct air capture system (ADAC) is disclosed. The ADAC includes a chamber, a water reservoir, and a sorbent that releases water under ambient conditions, binds water under a first moisture level higher than the ambient moisture level, binds CO₂ under ambient conditions, and releases CO₂ under at least one of an elevated temperature and the first moisture level. The ADAC is movable between a capture configuration and a regeneration configuration, the capture configuration including the sorbent being exposed to a gas volume having CO₂ under ambient conditions, the sorbent binding with CO₂ while desorbing water, the sorbent selected so the sorbent material extracts heat while the ADAC is in the capture configuration, resulting in the thermal charging of the sorbent. The regeneration configuration includes the sorbent inside the chamber and in contact with water, the sorbent releasing carbon dioxide while binding water and depositing heat into the chamber.

### RELATED APPLICATIONS

This application claims the benefit of U.S. Provisional Pat. Application 62/990,894, filed Mar. 17, 2020, titled “Autothermal CO₂ Direct Air Capture System,” the entirety of the disclosure of which is hereby incorporated by this reference.

### TECHNICAL FIELD

Aspects of this document relate generally to an autothermal direct air capture system.

### BACKGROUND

The need for technologies to remove carbon dioxide from the atmosphere has been well established. In addition to conservation, reduced-carbon processes, and on-site capture efforts, a significant amount of carbon dioxide will need to be removed from the atmosphere to avoid a looming climate change crisis. Technology that pulls carbon dioxide from the air or other dilute sources and turns it into a marketable and utilizable product can drive widespread adoption, if the capture and purification process is economical. The costs have to be competitive with other carbon sources to persuade the carbon-processing industries to change their carbon source to captured CO₂.

Unfortunately, many conventional air capture processes are expensive to set up and costly to operate, particularly the energy costs. Since the carbon dioxide in the ambient air is very dilute, atmospheric CO₂ collectors can quickly overrun a tight energy budget for drawing in and processing air.

### SUMMARY

According to one aspect, an autothermal direct air capture (ADAC) system includes a chamber having an interior, a water reservoir including water, a vacuum compressor in fluid communication with the interior of the chamber, and a sorbent material configured to release water under an ambient condition. The ambient condition includes an ambient temperature and an ambient moisture level. The sorbent material is further configured to bind water under a first moisture level that is higher than the ambient moisture level, bind carbon dioxide under the ambient condition, and release carbon dioxide under a release condition including at least one of a first temperature that is higher than the ambient temperature and the first moisture level. The ADAC system also includes a water resupply line in fluid communication with the water reservoir, a heat exchanger in thermal contact with the water resupply line and a product stream passing from the interior of the chamber and through the vacuum compressor, and a circulation compressor having an input and an output. The input and output are in fluid communication with the interior of the chamber. The ADAC further includes a sprayer in fluid communication with the water reservoir and the output of the circulation compressor. The ADAC system is movable between a capture configuration and a regeneration configuration. The capture configuration includes the sorbent material being positioned outside the chamber and exposed to a first gas volume including carbon dioxide under the ambient condition. The capture configuration also includes the sorbent material binding with carbon dioxide within the first gas volume while desorbing water into the first gas volume, the sorbent material selected so heat generated due to the adsorption of carbon dioxide is less than heat consumed in desorbing water, under the ambient condition, such that the sorbent material extracts heat while the ADAC system is in the capture configuration, resulting in the thermal charging of the sorbent material. The regeneration configuration includes the sorbent material being enclosed within the chamber, the water reservoir being put into fluid communication with the interior of the chamber such that the sorbent material is in contact with water, the sorbent material releasing the adsorbed carbon dioxide into the chamber while binding water inside the chamber and causing the sorbent material to deposit heat into the interior of the chamber, the vacuum compressor removing a carbon dioxide rich product stream from the interior of the chamber. Heat is transferred by the heat exchanger from the product stream removed from the chamber to the water as it passes through the water resupply line while the ADAC system is in the regeneration configuration. At least one of the sorbent material and the chamber moves while the ADAC system transitions to the regeneration configuration such that the sorbent material is enclosed within the interior of the chamber. The circulation compressor is configured to remove a portion of the gas within the interior of the chamber through the input and deliver the portion of the gas back to the interior of the chamber through the output, while the ADAC system is in the regeneration configuration. The sprayer is configured to spray water droplets into the interior of the chamber when the ADAC system is in the regeneration configuration, the droplets propelled by the gas delivered to the interior of the chamber by the circulation compressor.

Particular embodiments may comprise one or more of the following features. The sorbent material may include a moisture-swing material. The sorbent material may include a thermal-swing material. The transition from the capture configuration to the regeneration configuration may include at least the partial evacuation of the chamber. The chamber may be evacuated by the vacuum compressor while the ADAC system is in the regeneration configuration such that a partial pressure of water vapor within the chamber may be at least a majority of a total pressure within the chamber, while the ADAC system is in the regeneration configuration. The sorbent material may be a composite material including a first material configured to release water under the ambient condition and bind water under the first moisture level, and a second material configured to bind carbon dioxide under the ambient condition, and release carbon dioxide under the release condition. The water reservoir may be inside the chamber. The water within the water reservoir may be maintained at a supply temperature that is at most equal to the ambient temperature.

According to another aspect of the disclosure, an autothermal direct air capture (ADAC) system includes a chamber having an interior, a water reservoir having water, and a sorbent material configured to release water under an ambient condition including an ambient temperature and an ambient moisture level, bind water under a first moisture level that is higher than the ambient moisture level, bind carbon dioxide under the ambient condition, and release carbon dioxide under a release condition including at least one of a first temperature that is higher than the ambient temperature and the first moisture level. The ADAC system is movable between a capture configuration and a regeneration configuration. The capture configuration includes the sorbent material being exposed to a first gas volume having carbon dioxide under the ambient condition, the sorbent material binding with carbon dioxide within the first gas volume while desorbing water into the first gas volume, the sorbent material selected so heat generated due to the adsorption of carbon dioxide is less than heat consumed in desorbing water, under the ambient condition, such that the sorbent material extracts heat while the ADAC system is in the capture configuration, resulting in the thermal charging of the sorbent material. The regeneration configuration includes the sorbent material being enclosed within the chamber, the water reservoir being put into fluid communication with the interior of the chamber such that the sorbent material is in contact with water, the sorbent material releasing the adsorbed carbon dioxide into the chamber while binding water inside the chamber and causing the sorbent material to deposit heat into the interior of the chamber.

Particular embodiments may comprise one or more of the following features. The ADAC system may further include a water resupply line in fluid communication with the water reservoir, and/or a heat exchanger in thermal contact with the water resupply line and the product stream removed from the chamber. Heat may be transferred from the product stream removed from the chamber to the water as it passes through the water resupply line while the ADAC system is in the regeneration configuration. The capture configuration may further include the sorbent material positioned outside the chamber. At least one of the sorbent material and the chamber may move while the ADAC system transitions to the regeneration configuration such that the sorbent material is enclosed within the interior of the chamber. The sorbent material may be positioned within the interior of the chamber in both the capture configuration and the regeneration configuration. The first gas volume may pass through the interior of the chamber while the ADAC system is in the capture configuration. The sorbent material may be in direct contact with liquid water from the water reservoir while the ADAC system is in the regeneration configuration. The ADAC system may further include a sprayer in fluid communication with the water reservoir, the sprayer configured to spray water droplets into the interior of the chamber when the ADAC system is in the regeneration configuration. The ADAC system may further include a vacuum compressor in fluid communication with the interior of the chamber. The chamber may be evacuated by the vacuum compressor while the ADAC system is in the regeneration configuration such that a partial pressure of water vapor within the chamber is at least a majority of a total pressure within the chamber, while the ADAC system is in the regeneration configuration. The ADAC system may further include a circulation compressor having an input and an output, the input and output in fluid communication with the interior of the chamber, the circulation compressor configured to remove a portion of a gas within the interior of the chamber through the input and deliver the portion of the gas back to the interior of the chamber through the output, while the ADAC system is in the regeneration configuration. The gas delivered to the interior of the chamber by the circulation compressor may bubble through liquid water from the water reservoir after exiting the output of the circulation compressor, while the ADAC system is in the regeneration configuration. The ADAC system may further include a sprayer in fluid communication with the water reservoir, the sprayer configured to spray water droplets into the interior of the chamber when the ADAC system is in the regeneration configuration. The gas delivered to the interior of the chamber by the circulation compressor may propel the water droplets out of the sprayer and into the interior of the chamber. The first gas volume may be sized to maintain a temperature of the sorbent material close to the ambient temperature while providing the heat to desorb water while the ADAC system is in the capture configuration. The first gas volume may be one of ambient outdoor air, indoor air, flue gas, and gas from a fermenter. The ADAC system may further include a vacuum compressor in fluid communication with the interior of the chamber. The regeneration configuration may further include the vacuum compressor removing a carbon dioxide rich product stream from the interior of the chamber.

Aspects and applications of the disclosure presented here are described below in the drawings and detailed description. Unless specifically noted, it is intended that the words and phrases in the specification and the claims be given their plain, ordinary, and accustomed meaning to those of ordinary skill in the applicable arts. The inventors are fully aware that they can be their own lexicographers if desired. The inventors expressly elect, as their own lexicographers, to use only the plain and ordinary meaning of terms in the specification and claims unless they clearly state otherwise and then further, expressly set forth the “special” definition of that term and explain how it differs from the plain and ordinary meaning. Absent such clear statements of intent to apply a “special” definition, it is the inventors’ intent and desire that the simple, plain and ordinary meaning to the terms be applied to the interpretation of the specification and claims.

The inventors are also aware of the normal precepts of English grammar. Thus, if a noun, term, or phrase is intended to be further characterized, specified, or narrowed in some way, then such noun, term, or phrase will expressly include additional adjectives, descriptive terms, or other modifiers in accordance with the normal precepts of English grammar. Absent the use of such adjectives, descriptive terms, or modifiers, it is the intent that such nouns, terms, or phrases be given their plain, and ordinary English meaning to those skilled in the applicable arts as set forth above.

Further, the inventors are fully informed of the standards and application of the special provisions of 35 U.S.C. § 112(f). Thus, the use of the words “function,” “means” or “step” in the Detailed Description or Description of the Drawings or claims is not intended to somehow indicate a desire to invoke the special provisions of 35 U.S.C. § 112(f), to define the invention. To the contrary, if the provisions of 35 U.S.C. § 112(f) are sought to be invoked to define the inventions, the claims will specifically and expressly state the exact phrases “means for” or “step for”, and will also recite the word “function” (i.e., will state “means for performing the function of [insert function]”), without also reciting in such phrases any structure, material or act in support of the function. Thus, even when the claims recite a “means for performing the function of ... ” or “step for performing the function of... ,” if the claims also recite any structure, material or acts in support of that means or step, or that perform the recited function, then it is the clear intention of the inventors not to invoke the provisions of 35 U.S.C. § 112(f). Moreover, even if the provisions of 35 U.S.C. § 112(f) are invoked to define the claimed aspects, it is intended that these aspects not be limited only to the specific structure, material or acts that are described in the preferred embodiments, but in addition, include any and all structures, materials or acts that perform the claimed function as described in alternative embodiments or forms of the disclosure, or that are well known present or later-developed, equivalent structures, material or acts for performing the claimed function.

The foregoing and other aspects, features, and advantages will be apparent to those artisans of ordinary skill in the art from the DESCRIPTION and DRAWINGS, and from the CLAIMS.

### BRIEF DESCRIPTION OF THE DRAWINGS

The disclosure will hereinafter be described in conjunction with the appended drawings, where like designations denote like elements, and:

FIG. 1A is a schematic view of an autothermal direct air capture (ADAC) system in the capture configuration;

FIG. 1B is a schematic view of another embodiment of an ADAC system in the capture configuration;

FIG. 2A is a schematic view of the ADAC system of FIG. 1A in the regeneration configuration;

FIG. 2B is a schematic view of the ADAC system of FIG. 1B in the regeneration configuration; and

FIG. 3 is a top view of a composite sorbent material.

### DETAILED DESCRIPTION

This disclosure, its aspects and implementations, are not limited to the specific material types, components, methods, or other examples disclosed herein. Many additional material types, components, methods, and procedures known in the art are contemplated for use with particular implementations from this disclosure. Accordingly, for example, although particular implementations are disclosed, such implementations and implementing components may comprise any components, models, types, materials, versions, quantities, and/or the like as is known in the art for such systems and implementing components, consistent with the intended operation.

The word “exemplary,” “example,” or various forms thereof are used herein to mean serving as an example, instance, or illustration. Any aspect or design described herein as “exemplary” or as an “example” is not necessarily to be construed as preferred or advantageous over other aspects or designs. Furthermore, examples are provided solely for purposes of clarity and understanding and are not meant to limit or restrict the disclosed subject matter or relevant portions of this disclosure in any manner. It is to be appreciated that a myriad of additional or alternate examples of varying scope could have been presented, but have been omitted for purposes of brevity.

While this disclosure includes a number of embodiments in many different forms, there is shown in the drawings and will herein be described in detail particular embodiments with the understanding that the present disclosure is to be considered as an exemplification of the principles of the disclosed methods and systems, and is not intended to limit the broad aspect of the disclosed concepts to the embodiments illustrated.

The need for technologies to remove carbon dioxide from the atmosphere has been well established. In addition to conservation, reduced-carbon processes, and on-site capture efforts, a significant amount of carbon dioxide will need to be removed from the atmosphere to avoid a looming climate change crisis. Technology that pulls carbon dioxide from the air or other dilute sources and turns it into a marketable and utilizable product can drive widespread adoption, if the capture and purification process is economical. The costs have to be competitive with other carbon sources to persuade the carbon-processing industries to change their carbon source to captured CO₂.

Unfortunately, many conventional air capture processes are expensive to set up and costly to operate, particularly the energy costs. Since the carbon dioxide in the ambient air is very dilute, atmospheric CO₂ collectors can quickly overrun a tight energy budget for drawing in and processing air.

Contemplated herein is a system for autothermal direct air capture for carbon dioxide. The autothermal direct air capture systems (hereinafter ADAC system or ADAC) contemplated herein are able to operate with much lower energy requirements than conventional capture systems, by transferring thermal energy from the ambient air from which the CO₂ is being extracted into the system at a higher temperature. The thermal energy can be used to perform a thermal swing CO₂ desorption process, and/or to generate water vapor for the hydration of a CO₂ sorbent to trigger the release of CO₂ via a moisture-driven desorption.

In some embodiments, the capture and purification process of an ADAC system may only require a supply of water, a gas having CO₂, and sufficient electrical energy to operate devices such as pumps, motors, control devices, and the like. As will be discussed in greater detail below, the ADAC system comprises a sorbent material that can absorb water during a regeneration stage and desorb water when it is exposed to ambient air during a capture stage. The sorbent material also performs CO₂ absorption when contacting ambient air during the capture stage. The heat released from the sorbent material during water adsorption in the regeneration stage is again used for steam generation, which further hydrates the sorbent material until it is fully loaded with water. This results in a kind of self-amplifying sorption heat pump cycle. During the regeneration stage, carbon dioxide is desorbed because of the presence of water, elevated temperatures due to water adsorption, reduced total pressure due to water adsorption, or a combination of these factors. Hence, the operating costs of the ADAC system can be much lower than that of comparable capture systems that must use more valuable energy sources for the heat supply. This approach may also allow ADAC systems to be deployed in environments that would be less suitable for conventional capture systems.

It should be noted that while the following discussion of ADAC systems will be done in the context of capturing dilute CO₂ from ambient, atmospheric air, the systems contemplated herein may be adapted for use in capturing CO₂ from a variety of sources, including but not limited to indoor air, flue gas, and gaseous product streams from other production methods or processes such as fermenters and the like. Furthermore, the ADAC systems contemplated herein may also be adapted for use in the capture of other gases, using appropriate sorbent materials that have an affinity for said gases and also conform to the operating constraints to be discussed below.

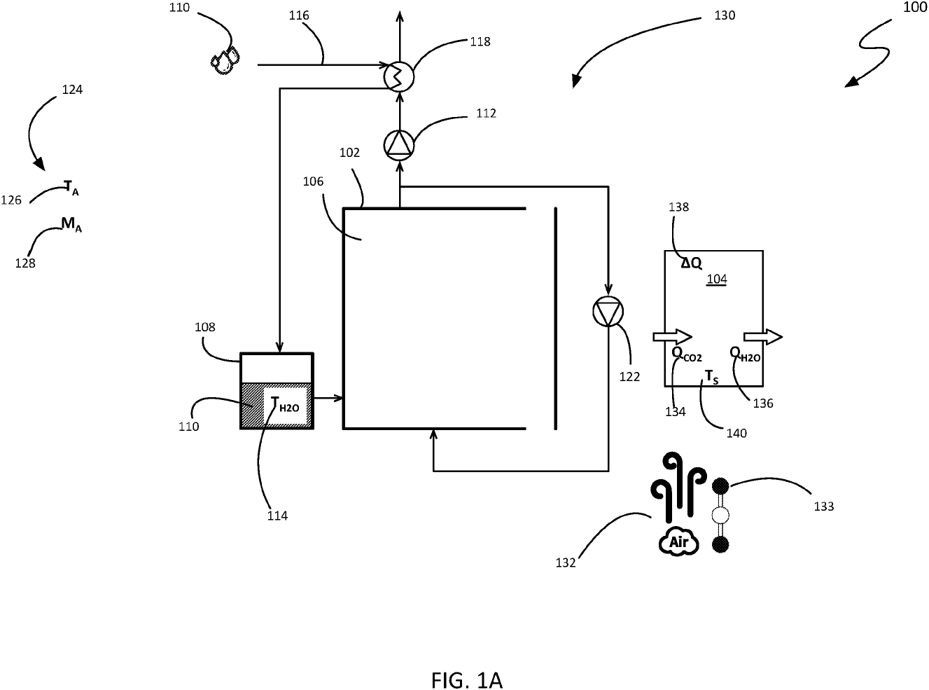

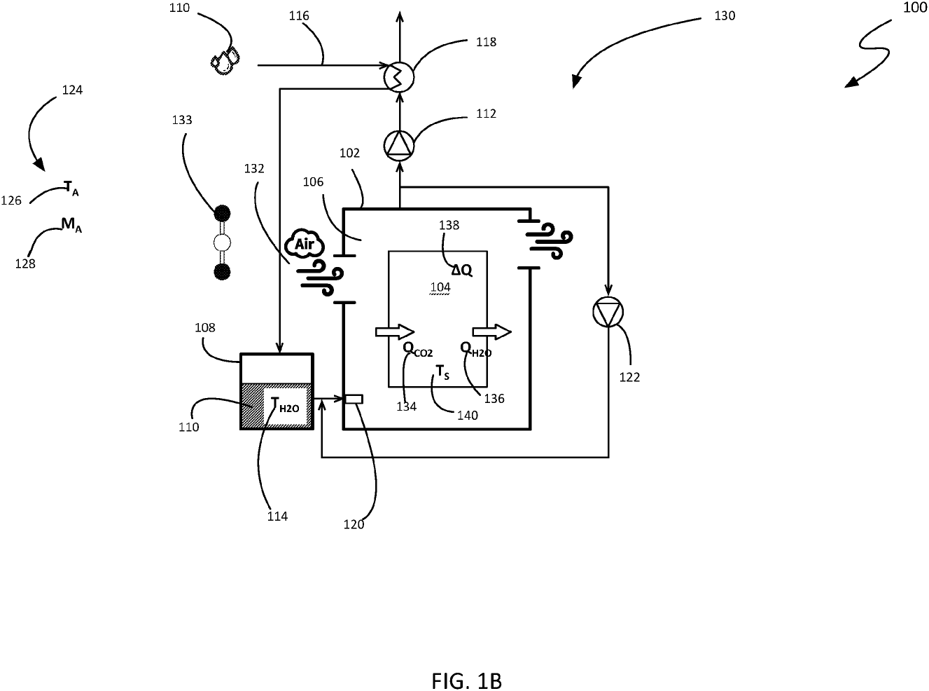

FIGS. 1A and 1B are schematic views of non-limiting examples of different embodiments of an ADAC system 100 in a capture configuration 130. As shown, the ADAC 100 comprises a chamber 102 having a hollow interior 106, a sorbent material 104, a water reservoir 108 containing water 110, and a vacuum compressor 112 in fluid communication with the interior 106 of the chamber 102. Some embodiments comprise additional elements, which will be discussed in greater detail, below.

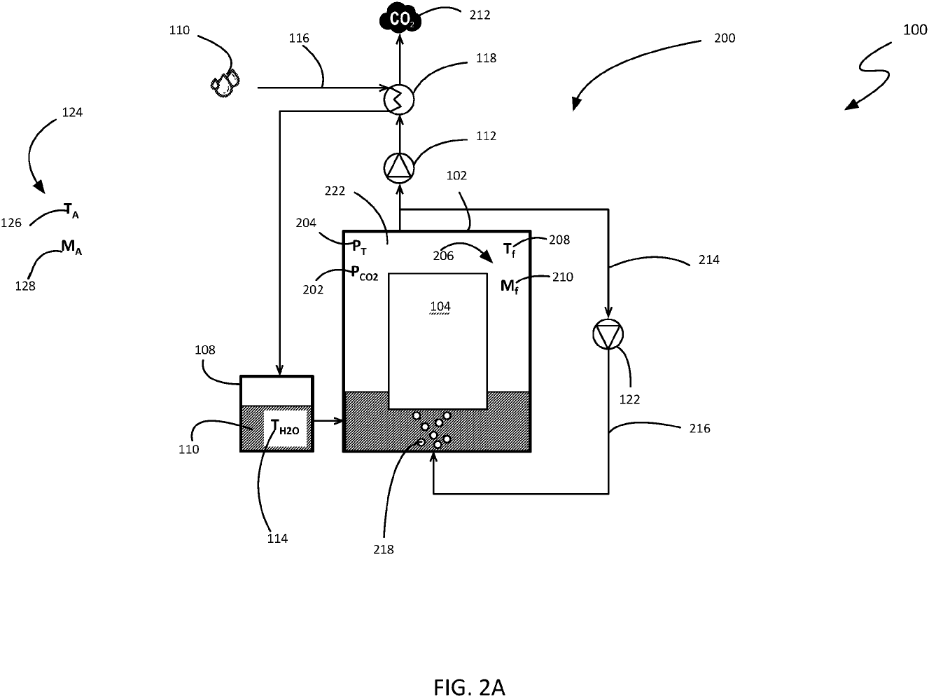

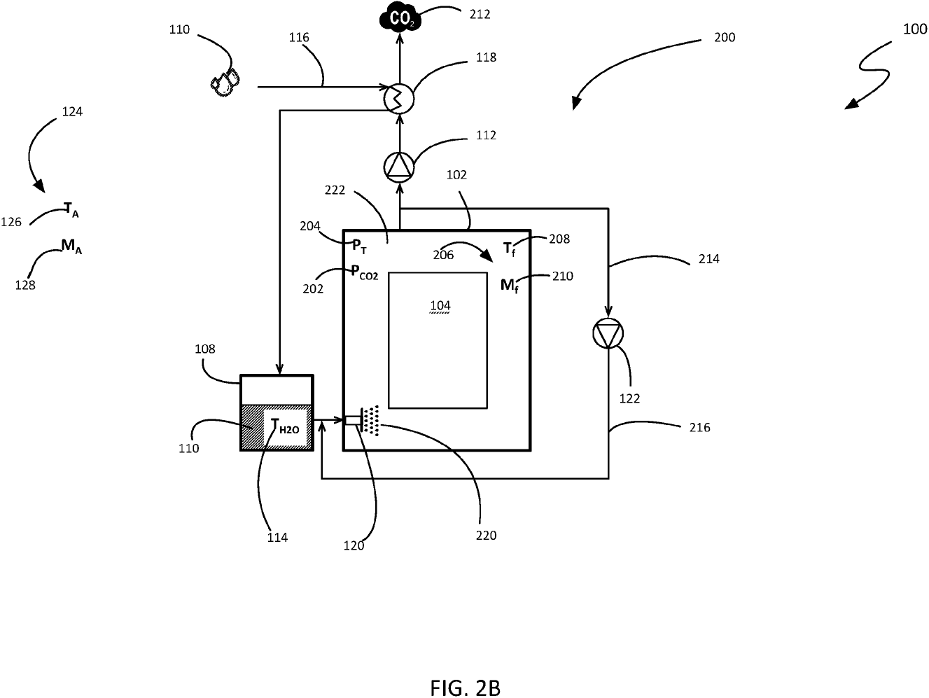

As shown, the ADAC 100 comprises a sorbent material 104. In the context of the present description and the claims that follow, a sorbent material 104 is a material that (1) can bind water under wet conditions and release water under an ambient condition 124 and (2) can bind CO₂ under the ambient condition 124 and release that CO₂ at elevated temperature and/or high moisture levels. This condition having an elevated temperature and/or high moisture levels (e.g. the previously mentioned wet conditions, a “first moisture level” etc.) will be referred to as a release condition, and will be discussed with respect to FIGS. 2A and 2B, below. These two different functionalities are central to the ADAC systems 100 ability to extract both CO₂ 133 and heat 138 from the ambient air.

According to various embodiments, the sorbent material 104 is chosen or configured such that it releases bound water under an ambient condition 124 comprising an ambient temperature 126 and an ambient moisture level 128. In the context of the present description and the claims that follow, a “condition” such as the ambient condition 124 is one or more characteristics describing the environment (e.g. atmosphere) localized around the ADAC 100, and in some cases localized around the sorbent material 104 itself. Ambient condition 124 refers to the temperature and moisture level of a first gas volume 132 comprising carbon dioxide that is in fluid and thermal contact with the ADAC 100. It should be noted that while many of the following examples are given in the context of an ADAC 100 operating outdoors, ambient condition 124 should not be construed to require an outdoor environment, and may also refer to any other first gas volume 132 comprising carbon dioxide that is in fluid and thermal contact with the ADAC 100 including, but not limited to, indoor atmosphere, output or by-product of another process, and the like. According to various embodiments, the ADAC 100 interacts with this first gas volume 132 in meaningful ways while in a capture configuration 130, as will be discussed below. In some embodiments, the first gas volume 132 may have additional beneficial interactions with the ADAC 100 independent of the configuration.

On the one hand, the sorbent material 104 binds CO₂ 133 with sufficient strength to remove CO₂ 133 from ambient air, (e.g. at a partial pressure of CO₂ of about 40 Pa, etc.) and temperatures 126 and relative humidity levels (e.g. ambient moisture levels 128) that are typical for ambient conditions 124 at a particular location. However, heating the sorbent material 104 and/or exposing it to moisture (depending on the nature of the sorbent material 104) will cause the release of the CO₂ 133. On the other hand, the sorbent material 104 is chosen for having a significant affinity to water vapor, with a binding energy for water vapor that exceeds the heat of condensation of water under similar temperature and pressure conditions, according to various embodiments. However, the affinity to water is sufficiently low for the sorbent material 104 to shed a significant amount of water 110 when it is moved from a condition of water saturation, or near saturation, to drier air conditions that reflect ambient conditions 124 in certain locations.

Furthermore, under ambient conditions 124 and according to various embodiments, the ratio of CO₂ uptake and water release is such that the sorbent material 104 cools as it absorbs CO₂ 133. In other words, the evaporative cooling for appropriately designed sorbent materials 104 overwhelms the heat 134 delivered by the adsorption of CO₂. The reverse is true while the ADAC 100 is in a regeneration configuration, where the water 110 adsorbed onto the sorbent material 104 will heat the sorbent material 104, and such heat is likely to exceed the cooling associated with the release of the bound CO₂ 133. The regeneration configuration will be discussed further with respect to FIGS. 2A and 2B, below.

According to various embodiments, the sorbent material 104 may take on a variety of forms, depending on the nature of the capture mechanism and the environment in which it is being used. Examples include, but are not limited to, filter or cloth-like structures that increase exposed surface area and may allow air to flow through them, fiber structures, tubular structures, one or more surfaces coated with one or more sorbents, meshes, disks, tiles, grids, arrays of plates, and the like. In some embodiments, the sorbent material 104 may be contained in a single unit, while in other embodiments, the sorbent material 104 may be in multiple segments spread apart to allow greater interaction with the atmosphere. In some embodiments, the sorbent material 104 may comprise a moisture-swing material, while in other embodiments it may comprise a thermal-swing material.

The ADAC 100 further comprises a water reservoir 108 containing liquid water 110 that will be introduced to the sorbent material 104 while the ADAC 100 is in a regeneration configuration. While FIGS. 1A and 1B depict the water reservoir 108 as being located outside of the chamber 102, it should be noted that these are schematic views showing how the various elements of the ADAC 100 interact. According to various embodiments, some or all of these elements may be housed within a shared thermally insulating housing, to enhance heat integration. In some embodiments, the water reservoir 108 may be outside of the chamber 102, while in other embodiments, it may be inside the chamber 102.

As shown, in some embodiments, a water resupply line 116 is in fluid communication with the water reservoir 108. This facilitates the replacement of water 110 lost during the operation of the ADAC 100 (e.g. cycling between configurations). Additionally, in some embodiments, the water resupply line 116 presents an additional opportunity to make use of heat that tends to be wasted by conventional capture systems, as will be discussed with respect to FIGS. 2A and 2B, below.

The liquid water 110 stored within the water reservoir 108 will be used to release the carbon dioxide 133 bound to the sorbent material while in a regeneration configuration. In some embodiments, this is facilitated by maintaining the water 110 within the reservoir 108 at a supply temperature 114 by some form of heat input. In some embodiments, the supply temperature 114 may be maintained at or below ambient temperature 126, allowing the heat to simply be ambient heat, which advantageously does not require any energy for delivery and does not increase the operational cost. In some embodiments, the water 110 within the reservoir 108 is in thermal contact with the ambient surroundings for at least a portion of the capture/regeneration cycle.

As shown, the ADAC 100 comprises a vacuum compressor 112 that is in fluid communication with the interior 106 of the chamber 102. The vacuum compressor 112 may be used to evacuate the chamber and/or extract a CO₂-enriched product stream. The vacuum compressor 112 will be discussed further in the context of the regeneration configuration, below. Additionally, some embodiments may further comprise a heat exchanger 118, a circulation compressor 122, and/or a sprayer 120. These embodiments will also be discussed with respect to FIGS. 2A and 2B, below.

According to various embodiments, an ADAC system 100 operates with a capture configuration 130 or stage, where CO₂ 133 is pulled from the atmosphere by the sorbent material 104 that is also releasing water vapor, and a regeneration configuration or stage, where the sorbent material 104 releases the captured CO₂ 133 while adsorbing water 110. The ADAC 100 is movable between these two configurations.

FIGS. 1A and 1B are schematic views of non-limiting examples of two embodiments of a ADAC 100 in the capture configuration 130. In the context of the present description and the claims that follow, the capture configuration 130 of an ADAC 100 is the state in which the sorbent material 104 is pulling carbon dioxide 133 out of a body of gas, such as the atmosphere or some other source. Specifically, the capture configuration 130 comprises the sorbent material 104 being exposed to a first gas volume 132 comprising carbon dioxide 133 under ambient condition 124. While in the capture configuration 130 the sorbent material 104 binds with carbon dioxide 133 within the first gas volume 132 while desorbing water 110 into the first gas volume 132. As discussed earlier, the sorbent material 104 is selected and designed so that heat generated 134 due to the adsorption of carbon dioxide 133 is less than heat consumed 136 in desorbing water 110, under the ambient condition 124, the net result being that the sorbent material 104 extracts heat 138 from the first gas volume 132 while the ADAC system 100 is in the capture configuration 130. This results in the thermal charging of the sorbent material 104, which will be used advantageously while the ADAC 100 is in the regeneration configuration, which will be discussed with respect to FIGS. 2A and 2B, below. In other words, the sorbent material 104 extracts heat from the first gas volume 132 without raising the temperature of the sorbent material 104, while it is drying out and adsorbing CO₂.

In some embodiments, this process is a (semi-)batch process, one step in the process being the capture of CO₂ 133 from the CO₂ source (e.g. the first gas volume 132), which for example is air, combined with the thermal charging of the sorbent material 104 through the evaporation of water 110. In other embodiments, this process may be implemented as a continuous process, with the ADAC 100 comprising elements that can be in either configuration, with both configurations active at the same time, and able to transition those elements from one configuration to the other in a continuous manner. For example, in some embodiments, the sorbent material 104 may form a continuous loop, so that as one part gradually moves from the capture configuration to the regeneration configuration, another part of the sorbent material 104 is moving from the regeneration configuration to the capture configuration. As an option, in one embodiment, the sorbent material 104 may be a liquid sorbent that is placed in contact with the first gas volume 132 in a suitable way (e.g. distributed over a surface, dispersed as droplets, etc.) in order to absorb CO₂ from that gas and then into the chamber 102, in a continuous liquid stream.

While this discussion is being done in the context of the first gas volume being ambient air, this disclosure is not limited to the capture of CO₂ from natural air currents and wind. In some embodiments, the first gas volume 132 may be a contained gas volume 132, rather than ambient outdoor air (e.g. indoor air, flue gas, gas from a fermenter, a product stream, etc.). Rather than limiting the system 100 contemplated herein to only unbounded atmospheric applications, it may be said that, in some embodiments, the first gas volume 132 is sized to be sufficiently large as to maintain a temperature 140 of the sorbent material close (e.g. within a few degrees, etc.) to the ambient temperature 126 (e.g. the temperature of the first gas volume 132) while providing the heat 136 to desorb water while the ADAC system 100 is in the capture configuration 130.

According to some embodiments, the sorbent material 104 is exposed to the first gas volume 132 at a relatively low humidity during capture. As the sorbent material 104 collects CO₂ 133, it also releases water vapor into the first gas volume 132 resulting in a net cooling of the sorbent material 104 and the gas that passes over it. For a large airmass flowing over/through the sorbent material 104, the process occurs near ambient temperatures 126.

The ADAC 100 may transition between the capture and regeneration configurations through a variety of mechanisms. In some embodiments, including the non-limiting example shown in FIG. 1A, the sorbent material 104 may be physically moved with respect to the chamber 102. While the ADAC 100 is in the capture configuration 130, the sorbent material 104 is not contained within the chamber 102, but is instead directly exposed to the first gas volume 132 (e.g. the atmosphere). FIG. 2A is a schematic view of this the non-limiting example shown in FIG. 1A, in the regeneration configuration 200. As shown, transitioning from the capture configuration 130 to the regeneration configuration 200 comprises moving the sorbent material 104 into the interior 106 of the chamber 102, which is sealed to enclose the sorbent material 104. It should be noted that in some embodiments the sorbent material 104 may be moved into a stationary chamber 102, and in other embodiments the chamber 102 may be moved to enclose and contain a stationary sorbent material 104.

As a specific example, in some embodiments, the ADAC 100 may comprise a sorbent material 104 in the form of a plurality of disks suspended below a lid that is lifted for the capture configuration 130, and then lowered to seal the disks inside the chamber 102 for the regeneration phase.

In other embodiments, the sorbent material 104 may be stationary with respect to the chamber 102. Instead, the chamber 102 may be configured to open as part of the capture configuration 130 and seal for the regeneration configuration 200. See, for example, the non-limiting example shown in FIGS. 1B and 2B. In still other embodiments, the sorbent material 104 may remain sealed inside a chamber 102 configured to execute both parts of the cycle (i.e. capture and regeneration) by bringing the needed materials (e.g. the first gas volume 132, water vapor/steam, etc.) inside the chamber 102. As a specific example, in some embodiments the sorbent material 104 may be a liquid sorbent. In both variations, the first gas volume 132 passes through the chamber 102 while the ADAC 100 is in the capture configuration 130.

FIGS. 2A and 2B are schematic views of non-limiting examples of an ADAC 100 in a regeneration configuration 200. Specifically, FIG. 2A is a schematic view of the ADAC system 100 of FIG. 1A in the regeneration configuration 200, and FIG. 2B is a schematic view of the ADAC system 100 of FIG. 1B in the regeneration configuration 200. In the context of the present description and the claims that follow, a regeneration configuration 200 comprises the sorbent material 104 being enclosed within the chamber 102 and the water reservoir 108 being put into fluid communication with the interior 106 of the chamber 102 such that the sorbent material 104 is in contact with water 110, whether it be in liquid or vapor form. While in this configuration 200, the sorbent material 104 releases the adsorbed carbon dioxide 133 into the chamber 102 while binding water 110 inside the chamber 102 and causing the sorbent material 102 to deposit heat 138 into the interior 106 of the chamber 102. Put differently, the heat collected by the sorbent material 104 while in the capture configuration 130 is transferred into the chamber 102 while in the regeneration configuration 200, against a temperature differential. Ultimately, the regeneration configuration 200 also comprises the vacuum compressor 112 removing a carbon dioxide rich product stream 212 from the interior 106 of the chamber 102.

According to various embodiments, the sorbent material 104 is selected and/or configured to bind water 110 when under a release condition 206 (as opposed to ambient condition 124, discussed previously). The release condition 206 comprises at least one of a first moisture level 210 that is higher than the ambient moisture level 128, and a first temperature 208 that is higher than the ambient temperature 126. The sorbent material 104 is selected and/or configured to release bound carbon dioxide when under the release condition 206.

According to various embodiments, the regeneration configuration of an ADAC system 100 comprises the CO₂-laden sorbent material 104 being enclosed in the chamber 102, which is then at least partially evacuated by the vacuum compressor 112. In some embodiments, it is substantially evacuated. After evacuation, the chamber 102 then is exposed to the liquid water reservoir 108 that is maintained at a supply temperature 114 by some form of heat input. In some embodiments, the supply temperature 114 is at or below ambient temperature 126, allowing the heat to simply be ambient heat, which does not require any energy for delivery and does not increase the operational cost. It should be noted that in other embodiments, which may not comprise a vacuum compressor 112, the chamber 102 may be exposed to water 110, in some form, by simply using a carrier gas (not shown), e.g. such as carbon dioxide.

In some embodiments, the chamber 102 is evacuated by the vacuum compressor 112 while the ADAC 100 is in the regeneration configuration 200 such that a partial pressure 202 of water vapor within the chamber 102 is at least a majority of a total pressure 204 within the chamber 102. The water vapor over the liquid water 110 of the reservoir 108 will aim to maintain a water vapor pressure in the chamber 102 that matches the equilibrium pressure over the water 110. At the same time, the adsorption of water at the sorbent material 104 surfaces will drive the pressure lower, forcing further evaporation of water 110. The process will stop when the temperature of the sorbent 140 is so high that it is in equilibrium with the same partial pressure 202 of water. For most sorbent materials 104 that have a heat of adsorption for water vapor in excess of the heat of condensation, this temperature will be higher than the supply temperature 114.

In some embodiments, the water reservoir 108 may be small. For example, the reservoir 108 might be comprised by a small liquid volume inside the chamber 102 in the form of water 110 that is in contact with interior 106 surfaces, or small droplets embedded into the gas volume within the chamber 102. With these smaller reservoirs 108, it is possible to heat up the water reservoir 108 against the warmer sorbent material 104 and thus drive temperatures even higher. For example, one embodiment comprises a direct gas/liquid heat exchange, accomplished by spraying the water as fine droplets 220 into the chamber 102 using a sprayer 120. These droplets 220 will tend to evaporate and pick up heat from the surrounding water vapor to maintain the same temperature. The water vapor in turn will adsorb onto the sorbent material 104, where it heats the sorbent material 104 to temperatures higher than that of the surrounding steam.

In other embodiments, where the density of the sorbent material 104 is too high to support the transport of droplets 220, liquid water 110 may be brought into direct contact with the heated sorbent surfaces 104. This in turn raises the temperature of the steam, and the cycle continues at a higher temperature. Ultimately, this process may be limited by the water storage capacity of the sorbent material 104.

One advantage that is obtained by these embodiments, where the majority of the total pressure 204 within the chamber 102 is delivered by the water vapor, is that water vapor can be applied evenly throughout the volume of the chamber 102. While liquid water 110 may accumulate in one section or another of the chamber 102, water vapor at low pressures will readily distribute itself by fluid dynamic pressure changes and thus reach every section of the chamber 102.

In other embodiments, parts of the gas 222 inside the chamber 102 may not be evacuated, and instead is circulated through the chamber 102 to provide a means of heat transfer from the sorbent material 104 to the water reservoir 108. In this way, it is possible to increase water condensation inside the chamber 102. By controlling the temperature difference between the sorbent material 104 and the water reservoir 108, a water vapor pressure differential can be maintained between the interior and the exterior (i.e. chamber 102 and the reservoir 108). It should be noted that the terms exterior and interior are here used to express different locations for steam generation and sorbent material 104 gathering or packing. However, this does not exclude embodiments where the location of both water vapor generation and sorbent material 104 gathering are housed within one thermally insulated apparatus, to optimize heat integration. Such a configuration may be advantageous in embodiments that rely on a moisture swing to remove CO₂ from the sorbent material 104.

In some embodiments, the circulation of the gas 222 remnants in the partially evacuated chamber may be accomplished with a circulation compressor 122. The circulation compressor 122 comprises an input 214 and an output 216, both in fluid communication with the interior 106 of the chamber 102. The circulation compressor 122 is configured to remove a portion of the gas 222 within the interior 106 of the chamber 102 through the input 214 and deliver the portion of the gas back to the interior 106 of the chamber 102 through the output 216 such that it interacts with the water 110 provided by or stored within, the water reservoir 108, while the ADAC 100 is in the regeneration configuration 200.

According to various embodiments, the chamber 102 has room for the introduction of gas while the ADAC 100 is in the regeneration configuration 200. This may be accomplished in a way that further achieves thermal transfer between the circulated gas and the water supply 108. See, for example, FIG. 2A, which is a schematic view of a non-limiting example of an ADAC 100 in the regeneration configuration 200. As shown, the gas delivered to the interior of the chamber by the circulation compressor bubbles through liquid water 110 from the water reservoir 108 after exiting the output 216 of the circulation compressor 122. These bubbles 218 facilitate the thermal transfer between the gas and the water. In some embodiments, this may be accomplished using a bubble column, or similar apparatus.

FIG. 2B is a schematic view of a non-limiting example of the ADAC 100 of FIG. 1B in the regeneration configuration 200. As shown, the ADAC 100 may comprise a sprayer 120 in fluid communication with the water reservoir 108 and configured to spray water droplets 220 into the interior 106 of the chamber 102. The gas delivered to the interior 106 of the chamber 102 by the circulation compressor 122 propels these water droplets 220 out of the sprayer 120 and into the chamber 102, according to various embodiments, facilitating the heat transfer between gas and liquid, as discussed above. Of course, in other embodiments, the sprayer 120 may be utilized to create water droplets 220 within the chamber 102 without a circulation compressor 122 being present.

Some embodiments may implement this concept of maximizing water deposition on the sorbent material 104 through the use of heat exchangers 118. As shown, in some embodiments, the ADAC 100 may comprise a heat exchanger 118 in thermal contact with the water resupply line 116 and the product stream 212, which comprises moist, hot carbon dioxide enriched gas. Heat is transferred from the product stream 212 removed from the chamber 102 to the water 110 as it passes through the water resupply line 116, while the ADAC system 100 is in the regeneration configuration 200.

According to some embodiments, the heat exchanger 118 surfaces inside the chamber 102 are maintained at a temperature that is intermediate to the ambient temperature of the water source and the temperature at which the water vapor pressure of the sorbent material 104 would equal that of the ambient water source. Heat is transferred from the sorbent 104, to the gas circulating in the chamber 102. The gas transfers heat to the heat exchanger 118 without condensation. Since the temperature of the sorbent 104 is lowered by the transfer of heat to the circulating gas in the chamber 102, it can proceed to bind more water.

Such a configuration may be advantageous because the sorbent material 104 has a strong tendency to even out its loading and heating. Any part of the sorbent 104 that is cooler than the average system 100 will tend to condense water out and thus heat up, any place that is hotter, will rapidly release water and thus cool down.

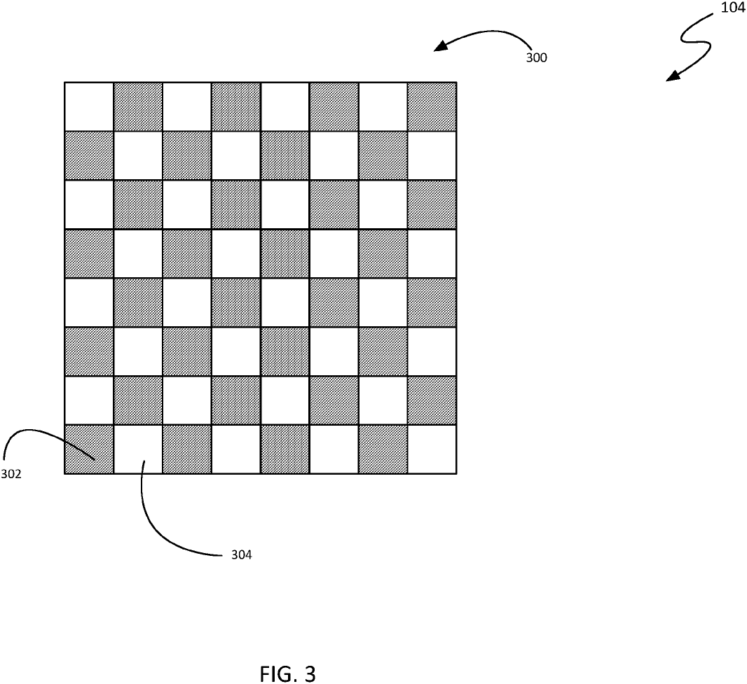

FIG. 3 is a top view of a non-limiting example of a composite sorbent material 300. In some embodiments, the sorbent material 104 may be homogeneous, combining the two properties concerning the binding and release of carbon dioxide and water into a single material. In other embodiments, the sorbent material 104 may comprise a composite material 300 where these two properties arise from two or more different compounds present and in close proximity to each other. According to various embodiments, the heterogeneity of the material 300 is on scales sufficiently small for heat transfer to result in an average temperature driven by the combination of water adsorption and CO₂ sorption or desorption.

More specifically, in some embodiments, the sorbent material 104 is a composite material 300 comprising a first material 302 configured to release water under ambient conditions 124 and bind water under the first moisture level 210 (e.g. a drying agent with isotherms that rise steeply at ambient water vapor pressures, etc.), and a second material 304 configured to bind carbon dioxide 133 under ambient conditions 124, and release carbon dioxide 133 under the release condition 206.

These two (or more) materials may be combined in a number of different ways, depending on the nature of the sorbent materials being used. For example, FIG. 3 shows a non-limiting example of a composite material 300 made of two fabric-type sorbents, a first material 302 and a second material 304, which have been woven together in strips small enough that heat transfer results in an average temperature driven by the combination of water adsorption and CO₂ sorption or desorption.

According to various embodiments, the sorbent material(s) 104 may include, but are not limited to, strong base anionic exchange resins (e.g. marathon A, polystyrene-based resins with quaternary ammonium ions, other quaternary ammonium ion exchange resins, etc.), secondary and tertiary amines, metal-organic frameworks, zeolith, and the like. In some embodiments, the sorbent material 104 may be solid, while in other embodiments, the sorbent material 104 may be, or may include a liquid sorbent (e.g. hygroscopic and strong alkaline liquids/solutions, etc.).

Because the sorbent material 104 must load up with water at high relative humidity and dry out a low relative humidity conditions that can be achieved outside, various embodiments of the ADAC system 100 operate within a set of constraints. In effect, these constraints can limit the binding energy of water to the sorbent.

As a specific, though simplified, example the sorbent material 104 may be characterized by the enthalpy change and entropy change in the sorption reaction. If the nominal values are given as, ΔH, and ΔS, respectively, then

$$Δ G = Δ H - T \left(Δ S + R ln p\right)$$

For many materials, ΔH and ΔS are approximately constant over a wide range of temperature and pressure conditions. Here, T is the temperature, R the universal gas constant, and p the pressure in units of the normal pressure (e.g., 1 atm), p = P/P₀.

Given a capture temperature T₁ and a regeneration temperature T₂, the pressure amplification in the thermal swing may be estimated:

$$\frac{{P}_{2}}{{P}_{1}} = {e}^{- \left(\frac{{T}_{2} - {T}_{1}}{{T}_{2}}\right) \left(\frac{Δ S + R ln {P}_{1} / {P}_{0}}{R}\right)}$$

For systems of interest, the entropy change under sorption is negative, as a result the amplification factor is larger than one, for heating. The amplification factor does not depend on ΔH. The bigger the entropy change is in absolute terms, the larger the multiplier can be. This suggests that sorbents that undergo entropic changes as they bind the sorbate can increase the pressure amplification.

For CO₂ capture, this means that the lowest regeneration temperature can be achieved by maximizing the entropy change. Even then, it may be difficult to go from ambient partial pressures to one atmosphere in a single step if the upper temperature is limited to less than 100° C. As has been pointed out by Tao Wang et al [Wang, T.; Lackner, K. S.; Wright, A. B. Moisture-Swing Sorption for Carbon Dioxide Capture from Ambient Air: A Thermodynamic Analysis. Phys. Chem. Chem. Phys. 2013, 15, (2), 504-514.], likely values for ΔS range from -130 to -218 J/mol/K.

At equilibrium, a solution for p = P/P₀ may be found:

$$\text{ln} p = - \frac{Δ S}{R} + \frac{Δ H}{R T}$$

In other words, the log of the pressure is a linear function of the inverse temperature. This equation can be applied not just to sorbents, but also to the condensation of water from water vapor. In this case, p is the saturation pressure of the water vapor at saturation, and ΔS, and ΔH the thermodynamic parameters of the condensation reaction. For the range of outside conditions, these two numbers are roughly constant.

For a sorbent material 104, similar parameters may be introduced, although here it is likely that the two terms depend on the loading condition of the sorbent. Going forward, it is assumed that these two terms may be compared to the terms in the condensation of water. In other words, multipliers are introduced that relate the various parameters

$$Δ {S}_{s o r b a n t} = {α}_{s} Δ {S}_{{H}_{2} O}$$

$$Δ {Η}_{s o r b a n t} = {α}_{H} Δ {H}_{{H}_{2} O}$$

Typically, the two log P lines for the sorbent and the condensation will intersect somewhere. The intersection point may be as

$$\frac{1}{{T}_{0}} = \frac{Δ {S}_{{H}_{2} O}}{Δ {H}_{{H}_{2} O}} \frac{{α}_{s} - 1}{{α}_{H} - 1}$$

Of interest are cases where α_{H} > 1 and αₛ ~1. Since both, ΔS_{H2O} and ΔH_{H2}O are negative, their ratio is positive. It is therefore the sign of the term αₛ ― 1 that determines the sign of the expression.

If the expression is negative, the two lines do not intersect for positive values of the temperature. At any temperature, the water vapor pressure over the sorbent in equilibrium is smaller than that over liquid water. Otherwise, there is a maximum temperature above which the sorbent will dry out, even in a water saturated environment.

A sorbent that binds water strongly enough to remove it from water saturated air, but not so strongly that it could not at least partially dry, when exposed to dry air, will warm up in a closed container, if it is exposed to moisture.

Contemplated herein is a method of estimating the temperature such a system can reach without introducing external heat sources. For purposes of this discussion it shall be assumed that the sorbent has been dried out in the open air. It is now contained in a closed, evacuated container that holds the sorbent and some structural materials. The heat capacity of the entire assembly per unit capacity of the sorbent is given by cᵥ. The heat capacity encompasses the structural material including the parts of the container that get heated in the process, the sorbent material and any water vapor or other gases in the gas space surrounding the sorbent. By injecting an amount of heat Q into the system the temperature of the system rises by

$$Δ T = \frac{Q}{{C}_{V}}$$

It can be assumed that the ADAC system 100 goes through a cycle, where at some point it is exposed to ambient temperature conditions, and at others the temperature is elevated. It is also assumed that at least some of the heat that was incorporated in the last hot stage of the cycle has been taken and used to preheat the sorbent chamber prior to its next warming cycle. If the ambient temperature is Tₒ and the peak regeneration temperature is T_{R}, then the starting temperature of the next cycle is going to be somewhere between these two temperatures.

$${T}_{0} \leq {T}_{S} \leq {T}_{R}$$

The more efficient the heat recovery system is, the closer it can get to the regeneration temperature, according to various embodiments.

It may be estimated how much additional heat is available to warm up the system by taking advantage of the heat of sorption for water that can be released in the process. The heat of adsorption of water vapor onto a sorbent material is given by

$${Q}_{V} = - Δ {H}_{S}$$

Here AHs is the enthalpy of the gas-solid adsorption reaction between water vapor and the sorbent material.

The heat of binding liquid water to the sorbent material is given by

$${Q}_{L} = - Δ {H}_{S} + Δ {H}_{W}$$

Where ΔH_{w}, is the enthalpy change during the condensation of water. In some embodiments, this number could be negative.

Heating up a chamber 102 which contains the sorbent 104, structural material (e.g. structure to hold the sorbent in an advantageous configuration, etc.) and some water vapor requires heat input which comes from contact with either water vapor at ambient temperature T₀, or from contact with liquid water at the same temperature. Water vapor in equilibrium with this temperature is always available, as a heat exchanger can extract heat from the environment to evaporate the water. The regeneration chamber can then heat up as long as the water vapor pressure over the sorbent remains lower than the saturation pressure under ambient conditions. At T₀, the equilibrium partial pressure of water vapor over the sorbent is lower than the saturation pressure at T₀, consequently the heat of adsorption can raise the temperature of the sorbent, until either the sorbent is saturated with water or the equilibrium pressure over the sorbent has risen to match the water vapor saturation pressure at T₀. The temperature at which the two pressures match is referred to as T₁ ≥ T₀. Assuming that the ADAC 100 has sufficient sorption capacity to reach this temperature, the material can be further heated if Q_{L} > 0, by presenting it with liquid water which is brought in at a temperature T₀, heats itself up to the temperature of the sorbent and then gets bound to the sorbent in the process releasing more heat. It is possible that Q_{L} is negative. If that were the case, then adding more water would be detrimental, as it would cool rather than heat the chamber. If Q_{L} > 0, the temperature in the chamber will rise further until either the sorbent is fully saturated, or the water vapor pressure in the chamber exceeds the saturated water vapor pressure at the same temperature. The temperature at which this happens is referred to as T2 ≥ T₁. In that case, water would condense elsewhere in the chamber rather than being absorbed onto the sorbent. Not all sorbents would have such a critical temperature. Even if they have such a temperature, it could be much higher than the temperature that can be reached by saturating the sorbent with water.

In short, the heat deposited into the chamber, per mole of sorbent water capacity is given as

$$Q = α {Q}_{V} + β {Q}_{L}$$

Where α + β ≤ 1, and β= 0 if Q_{L} < 0.

The temperature reached is a more or less linear function of Q. It will depend on the starting temperature and the heat capacity embedded into the system. If

$$T \left({Q}_{V}\right) \leq {T}_{1} \text{then} α = 1 , β = 0.$$

Otherwise, a < 1 is chosen, such that T(αQᵥ) = T₁. If Q_{L} > 0 and T(αQᵥ + (1 - α)Q_{L}) < T₂ then β = 1 - α

Otherwise, β < (1 - α) is chosen such that T(αQᵥ + (βQ_{L}) = T₂.

To simplify the discussion, it is assumed the sorbent material is a simple sorbent whose water sorption is characterized by ΔS_{S} and ΔH_{S}. Such a sorbent has a step function isotherm. Realistic sorbents will have an additional entropy term that is of the form ln(ϑ) -In (1 - ϑ).

The thermodynamics of this reaction can be anticipated with the condensation of water, which is characterized by ΔS_{w,} and ΔH_{W}.

The free energy of condensation or absorption can be written as

$$Δ G = Δ H - T \left(Δ S + R ln P\right)$$

Therefore, at equilibrium

$$\text{ln} P = - \frac{Δ S}{R} + \frac{Δ H}{R T}$$

In other words, the logarithm of the equilibrium pressure is a linear function of the inverse of T, with an intercept of

$$- \frac{Δ S}{R}$$

(which is positive) and slope of

$$\frac{Δ H}{R}$$

(which is negative).

Where the above examples, embodiments and implementations reference examples, it should be understood by those of ordinary skill in the art that other direct capture systems could be intermixed or substituted with those provided. In places where the description above refers to particular embodiments of autothermal direct air capture systems, it should be readily apparent that a number of modifications may be made without departing from the spirit thereof and that these embodiments and implementations may be applied to other capture technologies as well. Accordingly, the disclosed subject matter is intended to embrace all such alterations, modifications and variations that fall within the spirit and scope of the disclosure and the knowledge of one of ordinary skill in the art.

1. An autothermal direct air capture (ADAC) system, comprising:
a chamber comprising an interior;
a water reservoir comprising water;
a vacuum compressor in fluid communication with the interior of the chamber;
a sorbent material configured to release water under an ambient condition comprising an ambient temperature and an ambient moisture level, bind water under a first moisture level that is higher than the ambient moisture level, bind carbon dioxide under the ambient condition, and release carbon dioxide under a release condition comprising at least one of a first temperature that is higher than the ambient temperature and the first moisture level;
a water resupply line in fluid communication with the water reservoir;
a heat exchanger in thermal contact with the water resupply line and a product stream passing from the interior of the chamber and through the vacuum compressor;
a circulation compressor having an input and an output, the input and output in fluid communication with the interior of the chamber; and
a sprayer in fluid communication with the water reservoir and the output of the circulation compressor;
wherein the ADAC system is movable between a capture configuration and a regeneration configuration;
wherein the capture configuration comprises the sorbent material being positioned outside the chamber and exposed to a first gas volume comprising carbon dioxide under the ambient condition, the sorbent material binding with carbon dioxide within the first gas volume while desorbing water into the first gas volume, the sorbent material selected so heat generated due to the adsorption of carbon dioxide is less than heat consumed in desorbing water, under the ambient condition, such that the sorbent material extracts heat while the ADAC system is in the capture configuration, resulting in the thermal charging of the sorbent material;
wherein the regeneration configuration comprises the sorbent material being enclosed within the chamber, the water reservoir being put into fluid communication with the interior of the chamber such that the sorbent material is in contact with water, the sorbent material releasing the adsorbed carbon dioxide into the chamber while binding water inside the chamber and causing the sorbent material to deposit heat into the interior of the chamber, the vacuum compressor removing a carbon dioxide rich product stream from the interior of the chamber;
wherein heat is transferred by the heat exchanger from the product stream removed from the chamber to the water as it passes through the water resupply line while the ADAC system is in the regeneration configuration;
wherein at least one of the sorbent material and the chamber moves while the ADAC system transitions to the regeneration configuration such that the sorbent material is enclosed within the interior of the chamber;
wherein the circulation compressor is configured to remove a portion of the gas within the interior of the chamber through the input and deliver the portion of the gas back to the interior of the chamber through the output, while the ADAC system is in the regeneration configuration; and
wherein the sprayer is configured to spray water droplets into the interior of the chamber when the ADAC system is in the regeneration configuration, he droplets propelled by the gas delivered to the interior of the chamber by the circulation compressor.

2-3. (canceled)

4. The ADAC system of claim 1, wherein the transition from the capture configuration to the regeneration configuration comprises at least the partial evacuation of the chamber.

5. The ADAC system of claim 4, wherein the chamber is evacuated by the vacuum compressor while the ADAC system is in the regeneration configuration such that a partial pressure of water vapor within the chamber is at least a majority of a total pressure within the chamber, while the ADAC system is in the regeneration configuration.

6. The ADAC system of claim 1, wherein the sorbent material is a composite material comprising a first material configured to release water under the ambient condition and bind water under the first moisture level, and a second material configured to bind carbon dioxide under the ambient condition, and release carbon dioxide under the release condition.

7. The ADAC system of claim 6, wherein the water reservoir is inside the chamber, and wherein the water within the water reservoir is maintained at a supply temperature that is at most equal to the ambient temperature.

8. (canceled)

9. An autothermal direct air capture (ADAC) system, comprising:
a chamber comprising an interior;
a water reservoir comprising water; and
a sorbent material configured to release water under an ambient condition comprising an ambient temperature and an ambient moisture level, bind water under a first moisture level that is higher than the ambient moisture level, bind carbon dioxide under the ambient condition, and release carbon dioxide under a release condition comprising at least one of a first temperature that is higher than the ambient temperature and the first moisture level;
wherein the ADAC system is movable between a capture configuration and a regeneration configuration;
wherein the capture configuration comprises the sorbent material being exposed to a first gas volume comprising carbon dioxide under the ambient condition, the sorbent material binding with carbon dioxide within the first gas volume while desorbing water into the first gas volume, the sorbent material selected so heat generated due to the adsorption of carbon dioxide is less than heat consumed in desorbing water, under the ambient condition, such that the sorbent material extracts heat while the ADAC system is in the capture configuration, resulting in the thermal charging of the sorbent material; and
wherein the regeneration configuration comprises the sorbent material being enclosed within the chamber, the water reservoir being put into fluid communication with the interior of the chamber such that the sorbent material is in contact with water, the sorbent material releasing the adsorbed carbon dioxide into the chamber while binding water inside the chamber and causing the sorbent material to deposit heat into the interior of the chamber.

10-11. (canceled)

12. The ADAC system of claim 9, wherein the transition from the capture configuration to the regeneration configuration comprises at least the partial evacuation of the chamber.

13. The ADAC system of claim 9, further comprising:
a water resupply line in fluid communication with the water reservoir; and
a heat exchanger in thermal contact with the water resupply line and the product stream removed from the chamber;
wherein heat is transferred from the product stream removed from the chamber to the water as it passes through the water resupply line while the ADAC system is in the regeneration configuration.

14. The ADAC system of claim 9, wherein the capture configuration further comprises the sorbent material positioned outside the chamber, and wherein at least one of the sorbent material and the chamber moves while the ADAC system transitions to the regeneration configuration such that the sorbent material is enclosed within the interior of the chamber.

15. The ADAC system of claim 9, wherein the sorbent material is positioned within the interior of the chamber in both the capture configuration and the regeneration configuration, and wherein the first gas volume passes through the interior of the chamber while the ADAC system is in the capture configuration.

16. The ADAC system of claim 9, wherein the sorbent material is in direct contact with liquid water from the water reservoir while the ADAC system is in the regeneration configuration.

17. (canceled)

18. The ADAC system of claim 9, further comprising:
a vacuum compressor in fluid communication with the interior of the chamber;
wherein the chamber is evacuated by the vacuum compressor while the ADAC system is in the regeneration configuration such that a partial pressure of water vapor within the chamber is at least a majority of a total pressure within the chamber, while the ADAC system is in the regeneration configuration.

19. The ADAC system of claim 9, further comprising:
a circulation compressor having an input and an output, the input and output in fluid communication with the interior of the chamber, the circulation compressor configured to remove a portion of a gas within the interior of the chamber through the input and deliver the portion of the gas back to the interior of the chamber through the output, while the ADAC system is in the regeneration configuration.

20. The ADAC system of claim 19, wherein the gas delivered to the interior of the chamber by the circulation compressor bubbles through liquid water from the water reservoir after exiting the output of the circulation compressor, while the ADAC system is in the regeneration configuration.

21. (canceled)

22. The ADAC system of claim 9, wherein the sorbent material is a composite material comprising a first material configured to release water under the ambient condition and bind water under the first moisture level, and a second material configured to bind carbon dioxide under the ambient condition, and release carbon dioxide under the release condition.

23. The ADAC system of claim 9, wherein the water reservoir is inside the chamber.

24. The ADAC system of claim 9 wherein the water within the water reservoir is maintained at a supply temperature that is at most equal to the ambient temperature.

25. The ADAC system of claim 9, wherein the first gas volume is sized to maintain a temperature of the sorbent material close to the ambient temperature while providing the heat to desorb water while the ADAC system is in the capture configuration.

26. The ADAC system of claim 9, wherein the first gas volume is one of ambient outdoor air, indoor air, flue gas, and gas from a fermenter.

27. The ADAC system of claim 9, further comprising:
a vacuum compressor in fluid communication with the interior of the chamber;
wherein the regeneration configuration further comprises the vacuum compressor removing a carbon dioxide rich product stream from the interior of the chamber.
